(19) United States
(12) Patent Application Publication
(10) Pub. No.: US 2017/0322856 A1
(43) Pub. Date: Nov. 9, 2017

(54) SYSTEM AND METHOD FOR FACILITATING TESTING OF PERIPHERAL NODES

(71) Applicant: HCL Technologies Limited, Noida (IN)

(72) Inventors: Satheesh Nallusamy, Chennai (IN); Murali Krishnaan Gajapathy, Chennai (IN)

(21) Appl. No.: 15/585,432

(22) Filed: May 3, 2017

(30) Foreign Application Priority Data
May 5, 2016 (IN) 201611015727

(51) Int. Cl. G06F 11/273; G06F 13/42; G06F 11/22

(52) U.S. Cl. CPC G06F 11/273; G06F 11/221; G06F 13/4282

(57) ABSTRACT

A system and method for facilitating testing of peripheral devices is disclosed. The system can be a USB virtual device that storing a plurality of class libraries associated with a set of peripheral nodes. The plurality of class libraries enable communication between a peripheral node and a testing platform. The system receives an access request from the testing platform for initiating a test cycle on a target peripheral node from the set of peripheral nodes. The system activates a class library associated with the target peripheral node, from the plurality of class libraries for enabling communication between the testing platform and the target peripheral node. Further, the system transmits an acknowledgement message to the testing platform to initiate the test cycle on the target peripheral node, using the class library, based on a test suit corresponding to the target peripheral node.

### CROSS REFERENCE TO RELATED APPLICATIONS AND PRIORITY

The present application claims priority from Indian Patent Application No. 201611015727, filed on May 5, 2016, the entirety of which is hereby incorporated by reference.

### TECHNICAL FIELD

The present disclosure in general relates to Universal Serial Bus (USB) devices. More particularly, the present disclosure relates to a system and method for testing of hardware and/or software applications.

### BACKGROUND

A lot of computing operations include testing of electronic devices, such as laptops, mobile phones, video surveillance systems, gaming consoles and the like, having Universal Serial Bus (USB) nodes. The testing of these electronic devices generally involve a separate hardware device for testing each USB capability of the electronic device. For example, in case of testing of On the Go (OTG) devices such as mobile phones, different hardware USB devices may be required, in order to test one or more USB capabilities of the OTG device. Further, for each test, the different hardware USB devices have to be plugged and unplugged from the OTG device in order to continue the test. Furthermore, for each hardware USB device separate drivers may have to be installed separately. This may slow down the testing procedure, hence increasing the test time and effort.

### SUMMARY

This summary is provided to introduce aspects related to device and method for providing real-time navigation assistance to a rider, further described below in the detailed description. This summary is not intended to identify essential features of the claimed subject matter nor is it intended for use in determining or limiting the scope of the claimed subject matter.

In one implementation, a system for enabling testing of a peripheral node is disclosed. The system includes a memory and a processor coupled to the memory. The processor is configured to execute programmed instructions stored in the memory to store a plurality of class libraries associated with a set of peripheral nodes, wherein each class library is configured to enable communication between a testing platform and a peripheral node. The processor further executes programmed instructions to receive an access request, from the testing platform, for initiating a test cycle on a target peripheral node from the set of peripheral nodes. The processor further executes programmed instructions to activate a class library associated with the target peripheral node, from the plurality of class libraries for enabling communication between the testing platform and the target peripheral node. Further, the processor is further configured to execute programmed instructions to transmit an acknowledgement message to the testing platform to initiate the test cycle on the target peripheral node, using the class library, based on a test suit corresponding to the target peripheral node.

In another implementation, a method for enabling testing of a peripheral node is disclosed. The method includes storing, by a processor, a plurality of class libraries associated with a set of peripheral nodes, wherein each class library is configured to enable communication between a testing platform and a peripheral node. The method further includes receiving, by the processor, an access request, from the testing platform, for initiating a test cycle on a target peripheral node from the set of peripheral nodes. The method further includes activating, by the processor, a class library associated with the target peripheral node, from the plurality of class libraries for enabling communication between the testing platform and the target peripheral node. Further, the method includes, transmitting, by the processor, an acknowledgement message to the testing platform to initiate the test cycle on the target peripheral node, using the class library, based on a test suit corresponding to the target peripheral node.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates exemplary detailed workings of a system for testing a peripheral node, in accordance with an embodiment of the present disclosure.

FIGS. 2(A)-2(B) illustrate exemplary work cases of the system, in accordance with an embodiment of the present disclosure.

FIG. 3 illustrates a method for testing of a peripheral node, in accordance with an embodiment of the present disclosure.

### DETAILED DESCRIPTION

The present systems and methods will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

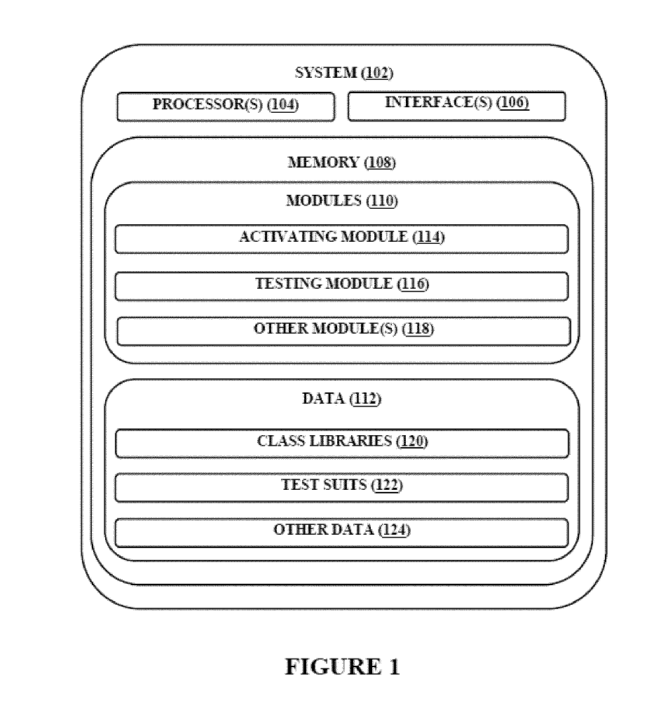

Referring to FIG. 1, a system 102 for testing one or more peripheral nodes is illustrated, in accordance with an embodiment of the present disclosure. In one embodiment, the system 102 may include at least one processor 104, an input/output (I/O) interface 106, and a memory 108. The at least one processor 104 may be implemented as one or more microprocessors, microcomputers, microcontrollers, digital signal processors, central processing units, state machines, logic circuitries, and/or any devices that manipulate signals based on operational instructions. Among other capabilities, the at least one processor 104 is configured to fetch and execute computer-readable instructions or modules stored in the memory 108.

The I/O interface 106 may include a variety of software and hardware interfaces, for example, a web interface, a graphical user interface, and the like. The I/O interface 106 may enable the system 102 to communicate with other computing devices, such as web servers and external data servers (not shown). The I/O interface 106 can facilitate multiple communications within a wide variety of networks and protocol types, including wired networks, for example, LAN, cable, etc., and wireless networks, such as WLAN, cellular, or satellite. The I/O interface 106 may include one or more ports for connecting a number of devices to one another or to another server. In specific examples, the I/O interface(s) 106 may include one or more communication interfaces such as Ethernet, RS232, or USB interface.

The memory 108 may include any computer-readable medium or computer program product known in the art including, for example, volatile memory, such as static random access memory (SRAM) and dynamic random access memory (DRAM), and/or nonvolatile memory, such as read only memory (ROM), erasable programmable ROM, flash memories, hard disks, optical disks, a compact disks (CDs), digital versatile disc or digital video disc (DVDs) and magnetic tapes. The memory 108 may include modules 110 and data 114.

The modules 110 include routines, programs, objects, components, data structures, etc., which perform particular tasks or implement particular abstract data types. In one implementation, the modules 110 may include an activating module 114, a testing module 116 and other modules 118. The other modules 118 may include programs or coded instructions that supplement applications and functions of the system 102.

The data 112, amongst other things, serves as a repository for storing data processed, received, and generated by one or more of the modules 108. The data 112 may also include class libraries 120, test suit 122 and other data 124. Other data 124, in one example, may be resulted by execution of one or more of the other modules 118. Each of the aforementioned modules is explained in detail in subsequent paragraphs of the specification.

In an embodiment, the system 102 may be a virtual Universal Serial Bus (USB) device. In the embodiment, the system 102 may act as a number of USB nodes such as USB camera, USB pen drive, USB joystick, USB keyboard, and the like for testing USB functionalities associated with a device under test (DUT) (not shown). The system 102 may act as a particular USB node based on an access request as received by a user (stand-alone mode) or by a testing platform (remote mode) for testing the peripheral node. For example, the DUT may be a video surveillance system, a computing device such as a laptop, an on the go (OTG) device such as mobile phone, a gaming console, and the like. It may be noted that the system 102 of the present disclosure may be operated under a device virtualization mode. That is, the system 102 may act as a virtual device with different USB device functionalities based on application or hardware being developed and/or tested.

In operation, the system 102 may be utilized for testing a target peripheral node (not shown) from one or more peripheral nodes of the DUT. In an implementation, the testing of the peripheral node may be initiated based on an access request received by the activating module 114. In one example, the access request may be received from the testing platform. The testing platform may be any remote computing system configured to execute test scripts on the peripheral node for testing one or more parameters associated with the peripheral node, including but not limited to, device settings, video settings, audio settings, image quality, response time, and the like.

In an implementation, the activating module 114, in response to receiving the access request, may identify the target peripheral node to be tested. For example, in case of a surveillance system under test, the activating module may determine that a video camera node is to be activated for testing. In another example, in case a gaming console is being tested, it may be determined that a joystick node of the gaming console is to be activated for testing.

Based on the target peripheral node identified, the activating module 114 may activate a class library associated with the target peripheral node, from the class libraries 120 pre-stored within the data 112 of the system 102. In an example, the class libraries may include mass data storage (MSD) class library, human interface device (HID) class library, communication device class (CDC) library, and the like.

In an implementation, the class library associated with the target peripheral node may be selected based on a type of the target peripheral node. For example, in case the DUT is a laptop and a USB pen drive node is to be tested, a MSD class library may be activated. In another example, in case the DUT is a video stream device, such that a USB camera node is being tested, an audio visual (AV) class library may be activated. It may be noted that activating a class library may essentially mean that the system 102 emulates the target peripheral node and behaves as the target peripheral node for the DUT. Taking the above example of the DUT being a laptop, the system 102 would act as USB pen drive device till the MSD class library is active. That is, the system 102 would behave as a USB pen drive till the testing is in progress.

Once the class library associated with the target peripheral node is activated, the testing module 116 may determine a test suit associated with the target peripheral device. In an implementation, the test suit may be obtained from the testing platform (in case of the remote mode operation) or from a plurality test suits pre-stored within the data 112 of the system 102 (in case of stand-alone mode operation). In an example, the test suit may include one or more test scripts and test commands required for testing of the peripheral node.

In one exemplary implementation, an acknowledgement regarding activation of the class library may be transmitted to the testing platform. Based on the acknowledgement, the testing platform may then initiate a test cycle using the test suit associated with the activated library. In case of a stand-alone mode operation, the test cycle may be automatically initiated using the test suit pre-stored in data 112. Further, once the test cycle is completed, the testing module 116 may transmit an acknowledgement of completion to the testing platform. Furthermore, the activating module 110 may deactivate the class library associated with the peripheral node being tested, once the test cycle in complete.

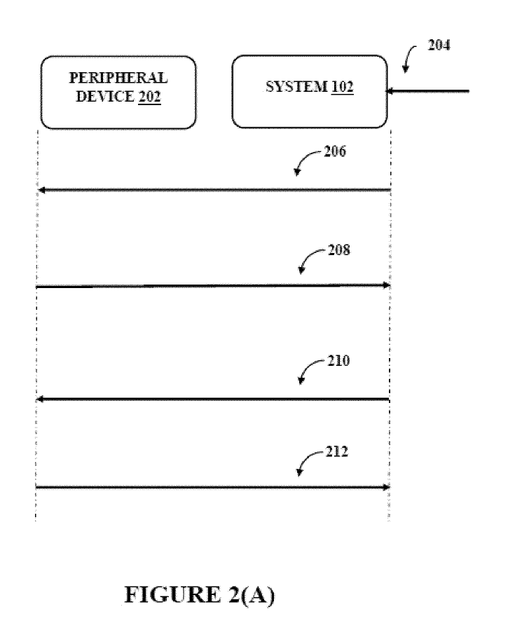

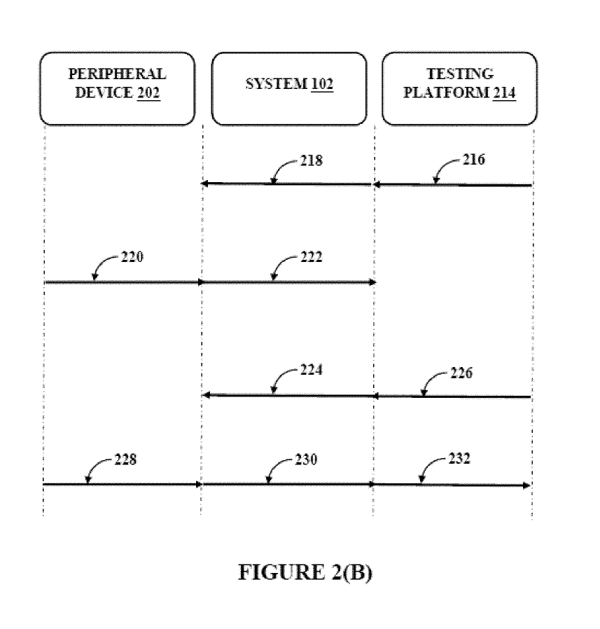

FIGS. 2(A) and 2(B) illustrate exemplary work cases for the system 102. FIG. 2(A) illustrates working of the system 102 in a stand-alone mode. As depicted, a DUT 202 may be communicatively coupled to the system 102. The DUT 202 may be an audio-video device, a gaming device, a laptop, a mobile phone, and the like. In an implementation, one or more peripheral nodes (not shown) of the DUT 202 may be tested using the system 102. In operation, an access request 204 may be received by the system 102. The access request 204, in one example, may include information regarding a particular peripheral node to be tested. For example, in case the DUT 202 is a gaming device, the access request 204 may indicate that a joystick node of the DUT 202 needs to be tested. In another example, the access request 204 may indicate that a graphics node needs to be tested.

Based on the access request, the system 102 may activate a class library associated with the peripheral node identified from the access request. In an example, in case a joystick node of the DUT 202 needs to be tested, a human interface device (HID) class library may be activated. As described in the foregoing, till the class library associated with the peripheral node remains active, the system 102 may operate as the peripheral node. Taking the above example, the system 102 may emulate a joystick node, thus acting as a joystick for the DUT 202. In an implementation, the system 102 may continue to operate as the peripheral node until testing of the DUT 202 is in progress or till the class library associated with the peripheral device is active.

Once the class library associated with the peripheral node is activated, the system 102 may transmit a notification 206 to the DUT 202. The notification 206 may include information associated with the peripheral node. The DUT 202 may receive the notification and prepare for testing of the peripheral node. Once the DUT 202 is ready, a test request 208 may be communicated from the DUT 202 to the system 102. In an example, the DUT 202 may initiate an enumeration process for the peripheral node. Further, the DUT 202 may also require a specific test script from the testing the peripheral node, based on the enumeration. For example, in case of the DUT 202 being a gaming console having a joystick node under test, the DUT 202 may require a test script for testing axis, point of view (POV) and/or joystick controls associated with the joystick node. The DUT 202 may request such a test script from the system 102 through the test request 208.

On receiving the test request 208 from the DUT 202, the system 102 may determine a relevant test suit from the test suits pre-stored within the system 102. Further, the system 102 may transmit 210 the determined test suit to the DUT 202. In an example, the test suit may contain test scripts, command sets, media files, and the like required for testing the peripheral node of the DUT 202. In one embodiment, the system 102, operating as the peripheral node for the DUT, executes the test suit on the DUT 202.

The DUT 202 may execute the test suit received from the system 102. In an implementation, the test suit may test operation of the DUT 202 with respect to one or more functionalities associated with the peripheral node. In the implementation, due to the system 102 operating as the peripheral node being tested, need for separate hardware is avoided. Further, in case any other peripheral node associated with the DUT 202 is to be tested, the system 102 may emulate the peripheral node, thus eliminating the need of plugging and unplugging of different peripheral devices.

After the testing of the peripheral node is complete, the test suit may be deactivated by the DUT 202. Once the test suit is deactivated, the DUT 202 may generate a termination request 212 and transmit it to the system 102. The system, based on the termination request, may deactivate the class library currently active.

FIG. 2(B) illustrates working of the system 102 in the remote mode. As illustrated, the DUT 202 may be connected to a testing platform 214, through the system 102. The testing platform 204, in an example, may be any computing device such as a personal computer, a workstation, a laptop, and the like. In an implementation, the testing platform 214 may include one or more Application Program Interfaces (API) associated with one or more peripheral nodes. Further, the testing platform 214 may also include test suits for testing the peripheral nodes. The test suits may include test scripts, audio/video files, and the like required for testing the peripheral node. In an implementation, the testing platform 214 may include one or more configuration files. The configuration files may be selected to be executed based on the peripheral node determined for testing.

Referring back to the figure, the testing platform 214 may send an access request 214 to the system 102. On receiving the access request 216, the system 102 may determine a peripheral node (not shown) to be tested. Based on the determination, the system 102 may activate a class library associated with the peripheral node. In an implementation, activation of the peripheral node may render the system 102 to operate as the peripheral node, without the requirement of a separate hardware required for the peripheral node.

After the activation of the class library, the system 102 may send a test request 218 to the DUT 202. The test request 218, in one example, may include a set of steps to be executed at the DUT 202 in order to prepare the DUT 202 for testing against one or more functionalities of the peripheral node. In an example, in case the DUT 202 is a video surveillance system and the peripheral node is a USB camera, the test request may comprise of steps to be executed in order to enumerate the USB camera. Based on success or failure of executing the test request, the DUT 202 may send a notification 220 to the system 102.

Once the system 102 receives the notification 220 indicating successful execution of the test request, the system 102 may request 222 for the test suit from the testing platform 214. The testing platform 214, on receiving the request 222, may identify the test suit relevant for the peripheral node to be tested. In one example, the test suit may be identified based on a configuration of the peripheral node. For example, in case the peripheral node is a USB camera, the test suit may contains test scripts as well as video files required to perform the testing of the USB camera. The testing platform may transmit 224 the test suit to the system 102. Further, the system 102 may forward 224 the test suit to the DUT 202.

Based on the received test suit, the DUT 202 may perform testing of the peripheral node. For example, in case of a video surveillance system, testing may be done on a stream quality, audio quality, video rendering, and the like for the USB camera. In another example, in case of a gaming console, testing may be done for gaming controls, joystick buttons, axial movement, and the like for a joystick node.

In an implementation, the DUT 202 may transmit a termination request 228 to the system 102 when testing of the peripheral node is complete. Based on the termination request 228, the system 102 may deactivate 230 the class library associated with the peripheral node. Further, the system 102 may send a termination confirmation 232 to the testing platform 214.

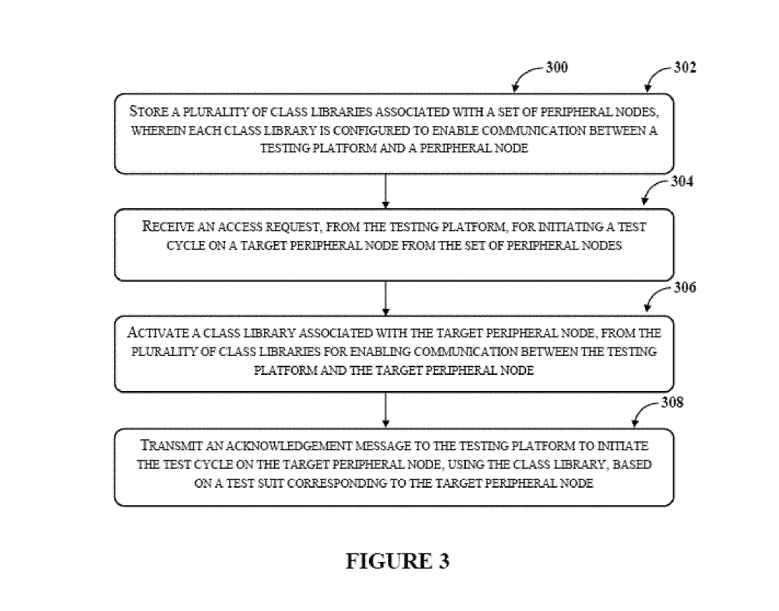

Referring now to FIG. 3, the method of facilitating navigational-aid to an UAV, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above described system 102.

At step 302, a plurality of class libraries associated with a set of peripheral nodes are stored. In an implementation, the plurality of class libraries may enable communication between a peripheral node and a testing platform.

At step 304, an access request from the testing platform may be received. In an implementation, the access request may initiate a test cycle on a target peripheral node from the set of peripheral nodes.

At step 306, a class library associated with the target peripheral node, from the plurality of class libraries for enabling communication between the testing platform and the target peripheral node.

At step 308, an acknowledgement message may be transmitted to the testing platform. The acknowledgement message may be transmitted to initiate the test cycle on the target peripheral node, using the class library, based on a test suit corresponding to the target peripheral node.

Although implementations for methods and systems for identifying relevant test cases have been described in language specific to structural features and/or methods, it is to be understood that the appended claims are not necessarily limited to the specific features or methods described. Rather, the specific features and methods are disclosed as examples of implementations for testing of peripheral nodes.

We claim:

1. A system to enable testing of a peripheral node, the system comprising:
a memory;
a processor coupled to the memory, wherein the processor is configured to execute programmed instructions stored in the memory to:
store a plurality of class libraries associated with a set of peripheral nodes, wherein each class library is configured to enable communication between a testing platform and a peripheral node;
receive an access request, from the testing platform, for initiating a test cycle on a target peripheral node from the set of peripheral nodes;
activate a class library associated with the target peripheral node, from the plurality of class libraries for enabling communication between the testing platform and the target peripheral node; and
transmit an acknowledgement message to the testing platform to initiate the test cycle on the target peripheral node, using the class library, based on a test suit corresponding to the target peripheral node.

2. The system of claim 1, wherein the set of peripheral node comprises a joystick, a USB camera, a USB keyboard, a USB mouse, a pen drive, and a USB data card.

3. The system of claim 1, wherein the test suit for testing one or more peripheral nodes from the set of peripheral nodes is maintained at the testing platform when the system operates in a stand-alone mode

4. The system of claim 1, wherein the processor is further configured to execute programmed instructions stored in the memory to store the test suit for testing one or more peripheral nodes from the set of peripheral nodes, when the system operates in a remote mode.

5. The system of claim 4, wherein the communication between the testing platform and the target peripheral mode is enabled through a communication interface, wherein the communication interface is one of a USB interface, a RS232 interface and an Ethernet.

6. The system of claim 1, wherein the processor is further configured to execute programmed instructions stored in the memory to store a configuration file, such that communication between the testing platform and the target peripheral node is based on the configuration file.

7. The system of claim 1, wherein the testing suit comprises at least one of a test script, a media file, and a command set to be executed during testing of one or more of the peripheral devices.

8. The system of claim 1, wherein the plurality of class libraries comprises a mass storage device (MSD) class library, a communication device class (CDC) library, a human interface device (HID), class library and an audio video (AV) class library.

9. A method for testing a peripheral node, the method comprising:
storing, by a processor, a plurality of class libraries associated with a set of peripheral nodes, wherein each class library is configured to enable communication between a testing platform and a peripheral node;
receiving, by the processor, an access request, from the testing platform, for initiating a test cycle on a target peripheral node from the set of peripheral nodes;
activating, by the processor, a class library associated with the target peripheral node, from the plurality of class libraries for enabling communication between the testing platform and the target peripheral node; and
transmitting, by the processor, an acknowledgement message to the testing platform to initiate the test cycle on the target peripheral node, using the class library, based on a test suit corresponding to the target peripheral node.

10. The method of claim 1, wherein the set of peripheral node comprises a joystick, a USB camera, a USB keyboard, a USB mouse, a pen drive, and a USB data card.

11. The method of claim 1, wherein the test suit for testing one or more peripheral nodes from the set of peripheral nodes is maintained at the testing platform.

12. The method of claim 1, further comprising storing, by the processor, the test suit for testing one or more peripheral nodes from the set of peripheral nodes.

13. The method of claim 1, wherein the testing suit comprises at least one of a test script, a media file, and a command set to be executed during testing of one or more of the peripheral devices.

14. The method of claim 1, wherein the plurality of class libraries comprises a mass storage device (MSD) class library, a communication device class (CDC) library, a human interface device (HID), class library and an audio video (AV) class library.
